(19) United States
(12) Patent Application Publication
(10) Pub. No.: US 2018/0313017 A1
(43) Pub. Date: Nov. 1, 2018

(54) DRIVING APPARATUS FOR WASHING MACHINE

(71) Applicant: NEW MOTECH CO., LTD., Gwangju (KR)

(72) Inventors: Jeong Cheol JANG, Gwangju (KR); Wang Gyu JEONG, Gwangju (KR); Beom Seok LEE, Gwangju (KR)

(73) Assignee: NEW MOTECH CO., LTD., Gwangju (KR)

(21) Appl. No.: 15/772,089

(22) PCT Filed: Oct. 6, 2016
(86) PCT No.: PCT/KR2016/011186

§ 371 Date: Apr. 30, 2018

(30) Foreign Application Priority Data
Dec. 24, 2015 (KR) 10-2015-0185975

(51) Int. Cl. D06F 37/40; F16H 1/28; F16H 55/36

(52) U.S. Cl. CPC D06F 37/40; F16H 2055/363; F16H 55/36; F16H 1/28

(57) ABSTRACT

A driving apparatus for a washing machine includes a clutch main body in which a brake drum is located inside; a clutch operation unit installed at one side of the clutch main body, the clutch operation unit including a brake lever and a clutch lever which rotates together when the brake lever operates; a clutch coupler located at the bottom of the clutch main body, the clutch coupler moving up and down by the clutch lever; a decelerator located at the bottom of the clutch coupler; a rotating driving means located at the bottom of the decelerator; a washing shaft in which a pulsator is coupled to the top end; and a dewatering shaft in which the washing shaft is rotatably coupled inside and a washing tub is coupled to the top end thereof.

### TECHNICAL FIELD

The present invention relates to a driving apparatus for a washing machine. More specifically, the present invention relates to a driving apparatus for a washing machine with a simple structure and capable of reducing the manufacturing cost by introducing a new structure which separates a brake drum located within a clutch housing from a decelerator.

### BACKGROUND ART

In general, the washing machine is largely divided into a pulsator type washing machine and a drum type washing machine. The drum type washing machine operates a drum-type tub by changing a rotation speed and torque so that a washing mode and a dewatering mode may be applied.

In the case of the pulsator type washing machine, a washing mode is performed by stopping the rotation of the washing tub in a state where laundry is located within the tub, and rotating the pulsator located within the washing tub to form water current. In the dewatering mode, the tub rotates so that laundry contained in the washing tub is dewatered by a centrifugal force.

To this end, common pulsator type washing machines include a washing shaft to rotate the pulsator, a dewatering shaft to rotate the washing tub, a clutch unit which selectively delivers a driving force of a motor or a pulley to the washing shaft and dewatering shaft according to the washing mode, and a brake unit which fixes the washing tub in a washing cycle.

According to Korean Patent No. 10-0593636 (hereinafter, ‘Related art 1’), since a decelerator including a planetary gear and a break drum are disposed in the middle of a washing shaft and a dehydration shaft, two components where the washing shaft is divided into a top washing shaft and a bottom washing shaft with respect to a brake drum, and the dehydration shaft is also divided into a top dehydration shaft and a bottom dehydration shaft. However, considering that the dehydration shaft and washing shaft are generally manufactured by forging a metal material, the manufacturing unit cost thereof is high. Therefore, since the dehydration shaft and washing shaft are divided into two components, there is a problem that the manufacturing unit cost increases. Additionally, the brake drum and planetary gear should be located within one housing, and thus the brake drum has a complex structure and is manufactured by the forging because of its problem in strength.

Meanwhile, in Related art 1, a brake lever and a clutch lever operate by their respective driving. Thus, there is a problem that an entire driving apparatus becomes complex and the manufacturing cost thereof becomes high. In order to solve this problem, Korean Patent No. 10-1548419 (hereinafter, ‘Related art 2’) introduces a structure allowing a clutch lever to rotate together when a brake lever operates.

However, although the brake lever according to Related art 2 has a simple structure, a pressing lever for converting a rotation direction of the brake lever into an operation direction of the clutch lever should be applied, which result in a problem that the number of components increases.

Accordingly, the present inventors suggests a driving apparatus for a washing machine with a new structure, in order to solve the above-mentioned problems.

### DISCLOSURE OF INVENTION

### Technical Problem

It is an object of the present invention to provide a driving apparatus for a washing machine with a new structure.

It is another object of the present invention to provide a driving apparatus for a washing machine capable of applying a washing shaft and a dewatering shaft as one component each by separating a brake drum from a decelerator, thereby simplifying the structure thereof and reducing the manufacturing cost thereof.

It is yet another object of the present invention to provide a driving apparatus for a washing machine capable of manufacturing a brake drum by pressing, not by forging since the structure of the brake drum becomes simple, thereby reducing the manufacturing cost thereof.

It is yet another object of the present invention to provide a driving apparatus for a washing machine capable of reducing the degree of abrasion of a bearing since a rotating driving means, like a pulley, and a washing shaft rotate in the same direction without controlling each other.

It is yet another object of the present invention to provide a driving apparatus for a washing machine capable of reducing the manufacturing cost by simplifying a rotating structure of a brake lever and a clutch lever.

The objects above of the present invention and other objects included therein may be easily carried out by the present invention explained in the following.

### Solution to Problem

A driving apparatus for a washing machine according to the present invention includes a clutch main body 1 in which a brake drum 13 is located inside; a clutch operation unit 2 installed at one side of the clutch main body 1, the clutch operation unit including a brake lever 21 and a clutch lever 22 which rotates together when the brake lever 21 operates; a clutch coupler 20 located at the bottom of the clutch main body 1, the clutch coupler moving up and down by the clutch lever 22; a decelerator 3 located at the bottom of the clutch coupler 20; a rotating driving means 4 located at the bottom of the decelerator; a washing shaft 5 in which a pulsator is coupled to the top end, the washing shaft being coupled to the rotating driving means 4 and rotating together with the decelerator 3; and a dewatering shaft 6 in which the washing shaft 5 is rotatably coupled inside and a washing tub is coupled to the top end thereof, the dewatering shaft penetrating a center of the clutch main body 1 and being rotatably coupled thereto.

According to the present invention, the clutch lever 22 preferably includes a top lever 221 which becomes the top and a bottom lever 222 which becomes the bottom with respect to a hinge unit 223. The hinge unit 223 is preferably coupled to a lever holder 231 which is fixed at one side of the clutch main body 1. A top inclination unit 221a with a shape inclined to the side direction is preferably formed in the top lever 221 such that a side inclination unit 211 formed at one side of the brake lever 21 is coupled to move along the top inclination unit 221a.

According to the present invention, the decelerator 3 may include a cup-shaped decelerator main body 31; a ring gear 312 formed on an inner wall of the decelerator main body 31; a carrier 30 which includes a planetary gear 303 engaged to the inside of the ring gear 312; and a decelerator cover 32 in which a plurality of hole-shaped coupler penetrating units 323 are formed in the center.

According to the present invention, a plurality of gums 202 may be formed, protruding downwardly, and a plurality of teeth 203 may be formed, protruding downwardly from the gum, in the bottom of the clutch coupler 20.

According to the present invention, it is preferable that a washing shaft coupling unit 302c through which the washing shaft 5 penetrates to be coupled thereto is formed in the center of the carrier, and a plurality of teeth insertion units 302c are formed in the top center of the carrier such that the teeth 203 of the clutch coupler 20 are inserted.

According to the present invention, the rotating driving means may include a pulley 41; a pulley gear 42 protruding upwardly from the center of the pulley; and a pulley bearing 43 coupled to the center of the pulley and rotatably supporting the bottom of the washing shaft 5.

According to the present invention, a fastening unit 55 is formed inside the bottom end of the washing shaft 5, and a fastening member 56 is coupled to the fastening unit such that the rotating driving means 4 and washing shaft 5 are coupled to rotate independently.

A driving apparatus for a washing machine according to the present invention which includes a clutch main body 1, a dewatering shaft 6 penetrating the center of the clutch main body 1, a washing shaft 5 rotatably coupled inside the dewatering shaft, and a clutch coupler 20 located at the bottom of the clutch main body 1, wherein the clutch main body 1 includes a brake drum 13 which controls the rotation of the dewatering shaft 6 by the operation of the brake lever 21, the brake lever 21 rotates together with the clutch lever 22 which moves the clutch coupler 20 up and down, the clutch lever 22 includes a top lever 221 which becomes the top and a bottom lever 222 which becomes the bottom with respect to a hinge unit 223, the hinge unit 223 is coupled to a lever holder 231 fixed at one side of the clutch main body 1, and a top inclination unit 221a with a shape inclined to the side direction is formed in the top lever 221 such that a side inclination unit 211 formed at one side of the brake lever 21 is coupled to move along the top inclination unit 221a.

A driving apparatus for a washing machine according to the present invention which includes a clutch main body 1, a dewatering shaft 6 penetrating the center of the clutch main body 1, a washing shaft 5 rotatably coupled inside the dewatering shaft, and a clutch coupler 20 located at the bottom of the clutch main body 1, further includes a rotating driving means causing the rotation of the washing shaft 5, wherein the rotating driving includes a pulley 41; a pulley gear 42 protruding upwardly from the center of the pulley; and a pulley bearing 43 coupled to the center of the pulley to rotatably support the bottom of the washing shaft 5.

A rotating driving means according to the present invention includes a pulley 41; a pulley gear 42 protruding upwardly from the center of the pulley; and a pulley bearing 43 coupled to the center of the pulley to rotatably support a rotation shaft.

### Advantageous Effects of Invention

The driving apparatus for a washing machine according to the present invention has the following effects:

(1) The present invention separates the brake drum from the decelerator, and thus the washing shaft and dewatering shaft can be applied as one component each, thereby simplifying the structure thereof and reducing the manufacturing cost.

(2) According to the present invention, the structure of the brake drum becomes simplified, and thus the brake drum can be manufactured by pressing, not by forging, thereby reducing the manufacturing cost.

(3) According to the present invention, the rotating driving means, like a pulley, and the washing shaft rotate in the same direction without controlling each other, thereby reducing the degree of abrasion of the bearing.

(4) According to the present invention, the rotating structure of the brake lever and clutch lever becomes simplified, thereby reducing the manufacturing cost.

### BRIEF DESCRIPTION OF DRAWINGS

FIG. 1 is a perspective view illustrating a driving apparatus for a washing machine according to the present invention;

FIG. 2 is an exploded perspective view illustrating a clutch main body of the driving apparatus for a washing machine according to the present invention;

FIG. 3 is a perspective view illustrating a clutch operation unit of the driving apparatus for a washing machine according to the present invention;

FIG. 4 is a perspective view illustrating a rotating driving means, a washing shaft and a dewatering shaft of the driving apparatus for a washing machine according to the present invention;

FIG. 5 is an exploded perspective view illustrating the rotating driving means, washing shaft and dewatering shaft of the driving apparatus for a washing machine according to the present invention;

FIG. 6 is an exploded perspective view illustrating a decelerator, the rotating driving means, washing shaft and dewatering shaft of the driving apparatus for a washing machine according to the present invention;

FIG. 7 is an exploded perspective view illustrating the decelerator and rotating driving means of the driving apparatus for a washing machine according to the present invention;

FIG. 8 is a cross section illustrating a state when the driving apparatus for a washing machine according to the present invention is in a washing mode; and

FIG. 9 is a cross section illustrating a state when the driving apparatus for a washing machine according to the present invention is in a dewatering mode.

Hereinafter, the present invention will be explained in detail with reference to the accompanying drawings.

### MODE FOR THE INVENTION

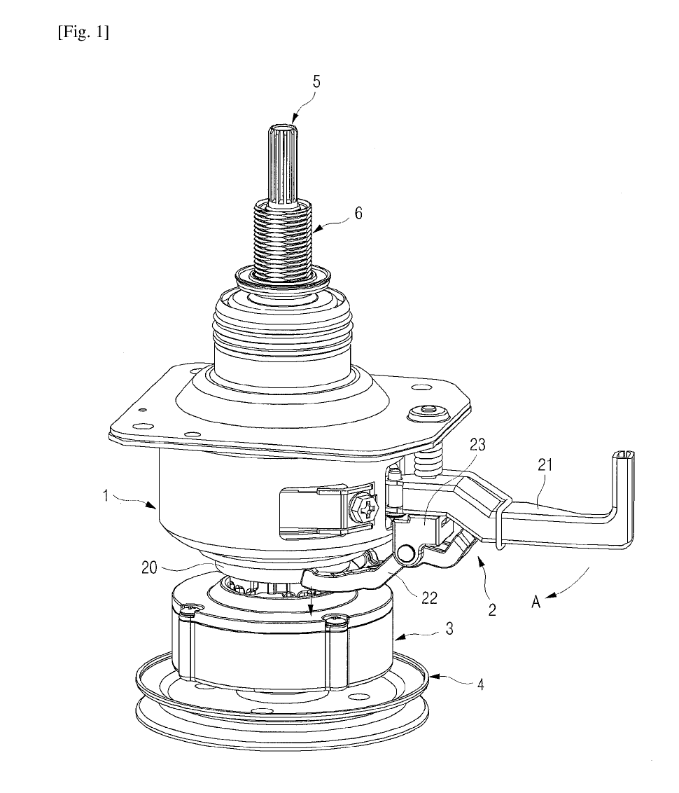

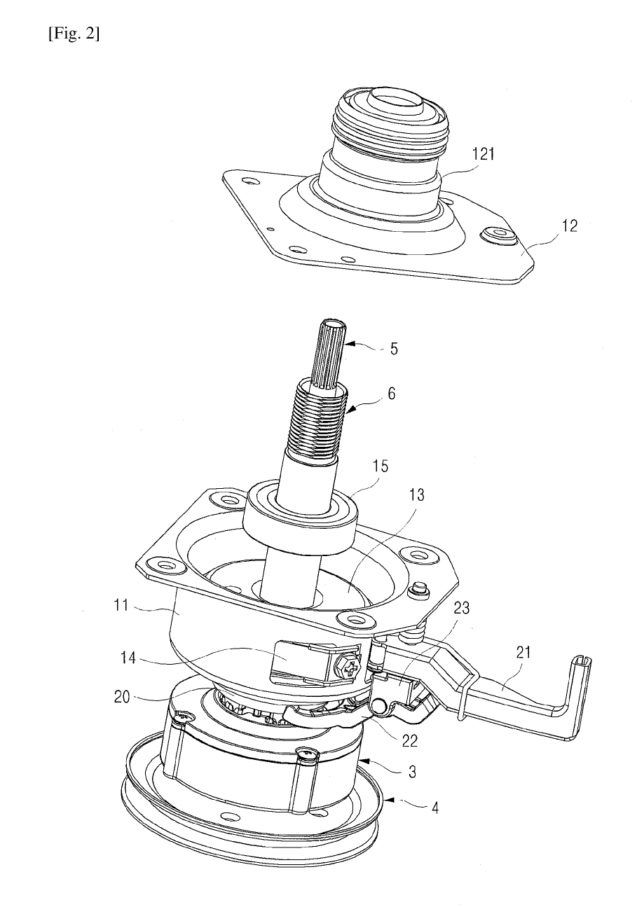

FIG. 1 is a perspective view illustrating a driving apparatus for a washing machine according to the present invention, and FIG. 2 is an exploded perspective view illustrating a clutch main body 1 of the driving apparatus of the washing machine according to the present invention. As illustrated in FIG. 1 and FIG. 2, the driving apparatus for a washing machine according to the present invention includes the clutch main body 1, a clutch operation unit 2, a decelerator 3, a rotating driving means 4, a washing shaft 5 and a dewatering shaft 6.

The clutch main body 1 includes a bottom housing 11 and a top housing 12, and a brake drum 13 is located in a space inside the bottom housing 11. The brake drum 13 prohibits or stops the rotation of the dewatering shaft 6 when a brake band 14 is pulled by the operation of a brake lever 21. According to the present invention, since the decelerator 3 is located outside of the clutch main body 1, separate from the brake drum 13, the structure of the brake drum 13 can be simplified. Additionally, the brake drum can be manufactured by pressing, not by forging, and thus the manufacturing cost can be reduced.

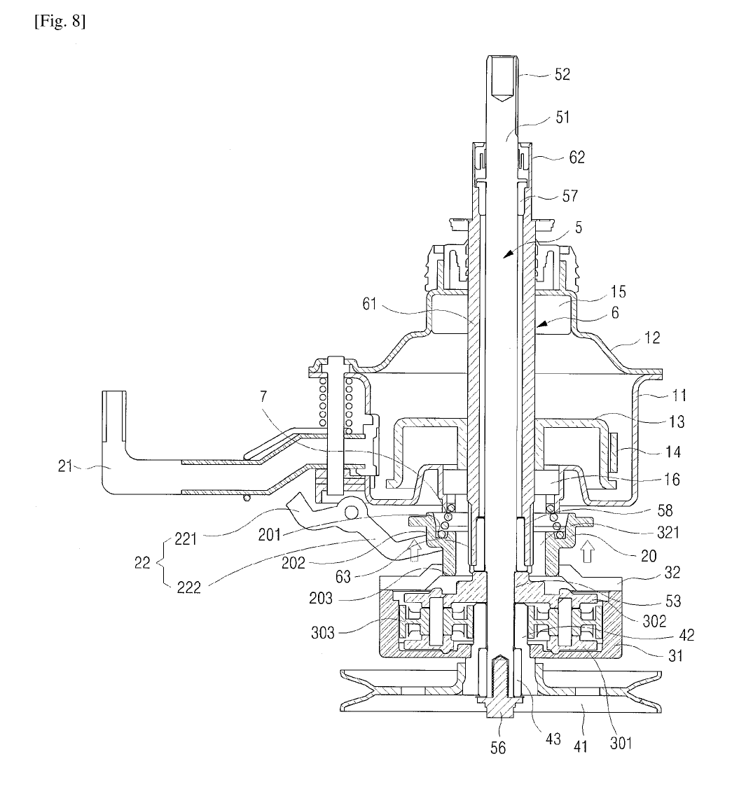

A center portion of the top housing 12 has a shape of a top protrusion unit 121 protrudingupwardly, and a first dewatering shaft bearing 15 for rotatably supporting the top of the dewatering shaft 6 is coupled to the inside of the top protrusion unit 121. As illustrated in FIG. 8, a second dewatering shaft bearing 16 for rotatably supporting the bottom of the dewatering shaft is coupled to a center portion inside the bottom of the bottom housing 11.

The brake band 14 and clutch coupler 20 operate together by the operation of the brake lever 21. When the brake lever 21 is located as illustrated in FIG. 1, the brake band 14 presses the brake drum 13, and the brake drum 13 presses the dewatering shaft 6 to control the dewatering 6 not to rotate. A clutch lever 22 which rotates with the brake lever 21 is located to maintain a state where the clutch coupler 20 rises. In this case, the decelerator 3 decelerates a rotation speed of the washing shaft 5. This state of operation is a washing mode. In the case of a dewatering mode, when the brake lever 21 rotates in the direction of A in FIG. 1, the brake band 14 is released, and thereby the brake drum 13 does not control the rotation of the dewatering shaft 6. At the same time, the clutch lever 22 rotates with the brake lever 21 to lower the clutch coupler 20. When the clutch coupler 20 lowers, the washing shaft 5 and dewatering shaft 6 rotate together, since the entire decelerator 3 rotates with the rotating driving means 4 at a uniform velocity.

The clutch operation unit 2 is installed at one side of the bottom housing 11. The clutch operation unit 2 includes the brake lever 21, the clutch lever 22 rotating with the brake lever 21, and a lever holder 23 which is a hinge portion supporting the rotation of the clutch lever 22. The brake lever 21 operates the brake band 14, and the clutch lever 22 operates the clutch coupler 20 to the up and down direction.

The decelerator 3 installed under the clutch main body 1 is to decelerate the rotation of the washing shaft 5 in the washing mode. The rotating driving means 4 is illustrated as having a shape like a pulley in FIG. 1, but is not limited to the pulley. Instead of the pulley, a rotating driving means like a motor shaft can be applied.

A pulsator (not illustrated) is coupled to the top end of the washing shaft 5, and the rotation of the washing shaft 5 causes the rotation of the pulsator. A washing tub is coupled to the top end of the dewatering shaft 6, and the rotation of the dewatering shaft 6 causes the rotation of the washingtub. The washing shaft 5 is inserted into the inside of the dewatering shaft 6 and rotates separately from the dewatering shaft 6. The detailed description with regard to these features will be provided again below.

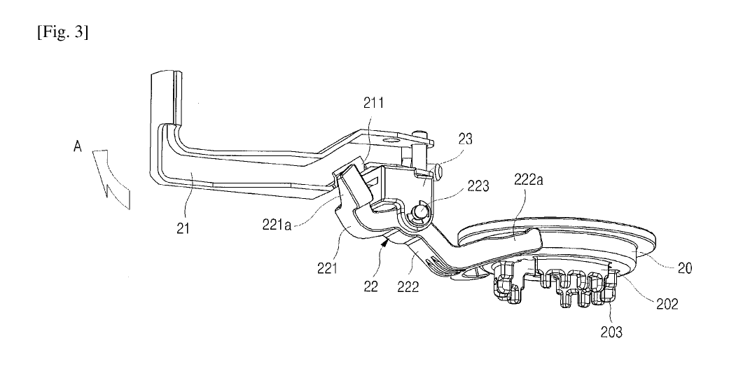

FIG. 3 is a perspective view illustrating the clutch operation unit 2 of the driving apparatus for a washing machine according to the present invention. Referring to FIG. 3, the clutch operation unit 2 of the present invention includes the clutch coupler 20, brake lever 21, clutch lever 22 and lever holder 23.

The brake lever 21 does a rotation movement within a certain range to the direction of A or opposite direction thereto in FIG. 3. When the brake lever 21 is located as illustrated in FIG. 3, the driving apparatus for a washing machine according to the present invention operates in the washing mode. When the brake lever 21 operates in the direction of A, the driving apparatus for a washing machine according to the present invention operates in the dewatering mode.

A side inclination unit 211 is formed at one side of the bottom end of the brake lever 21. The side inclination unit 211 moves along a top inclination unit 221a formed in a top lever 221 of the clutch lever 22. In the washing mode, the side inclination unit 211 and top inclination unit 221a contact with each other as illustrated in FIG. 3. When the washing mode is converted into the dewatering mode, the side inclination unit 211 moves along the top inclination unit 221a, and then two parts are separated from each other.

The clutch lever 22 includes the top lever 221 and bottom lever 222. A hinge unit 223 is formed in the boundary between the top lever 211 and bottom lever 222. The hinge unit 223 is coupled to the lever holder 23 coupled to the clutch main body 1 so that the clutch lever 22 rotates around the hinge unit 223. A coupler supporting unit 222a is formed in the bottom lever 222. The coupler supporting unit 222a supports the bottom of the clutch coupler 20 so that when the clutch lever 22 does a hinge movement, the coupler supporting unit 222a of the bottom lever 222 moves together to move the clutch coupler 20 up and down. A hole is formed in the center of the clutch coupler 20 so that the dewatering shaft 6 penetrates there into. Gums 202 and a plurality of teeth 203 protruding down wardly are formed at the bottom of the clutch coupler 20. The teeth 203 determine whether the decelerator 3 performs a function of decelerating the speed.

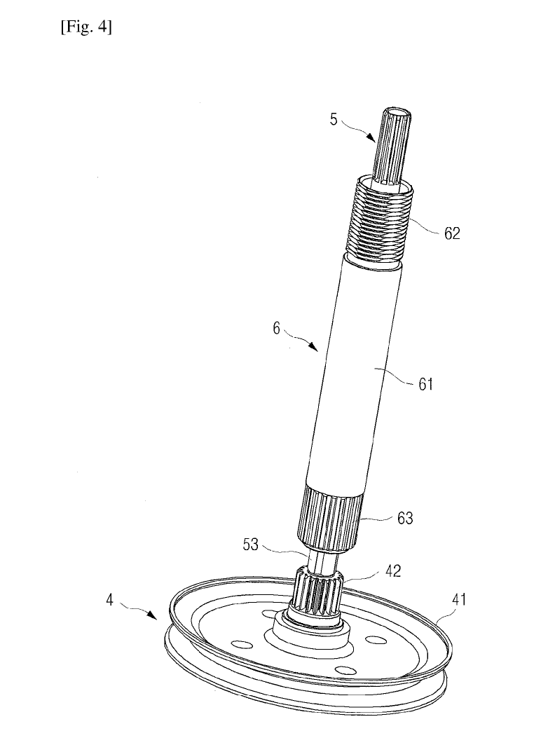

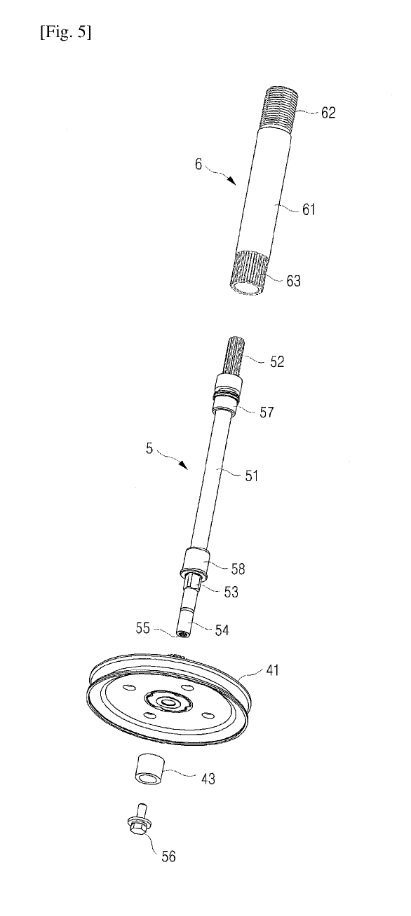

FIG. 4 is a perspective view illustrating the rotating driving means 4, washing shaft 5 and dewatering shaft 6 of the driving apparatus for a washing machine according to the present invention, and FIG. 5 is an exploded perspective view thereof.

As illustrated in FIG. 4 and FIG. 5, the rotating driving means 4 of the present invention includes a pulley 41, a pulley gear 42 which is fixed to or integrated with the pulley to rotate together with the pulley 41, and a pulley bearing 43 fixedly coupled to a center hole of the pulley to rotatably support the bottom of the washing shaft 5. In a state where a pulley bearing supporting unit 54 at the bottom end of the washing shaft 5 is supported, the coupling of the rotating driving means 4 and washing shaft 5 is made by fastening a fastening member 56 such as a bolt, a screw, a rivet, a hook, etc. into a fastening unit 55 such as a screw thread, an inclination surface, etc. formed in an inner hole at the end of the washing shaft 5. In this coupled state, the washing shaft 5 and pulley 41 rotate independently. In other words, when the pulley 41 rotates by the operation of a belt (not illustrated) fastened to the pulley 41 and a motor shaft (not illustrated), only the pulley bearing 43 rotates in the pulley bearing supporting unit 54, and the washing shaft 5 does not rotate.

Of course, instead of the pulley 41, a member which is directly fixed to the motor shaft may be used as the rotating driving means 4. In this case, the member has a shape like a pulley gear at the top and is directly connected to the motor shaft. In order for the motor shaft and washing shaft 5 to rotate independently, a bearing is fixedly coupled to the bottom of the center thereof.

The washing shaft 5 includes a washing shaft main body 51, a pulsator coupling unit 52 formed at the top of the washing shaft main body 51, to which the pulsator (not illustrated) is coupled, a carrier coupling unit 53 which receives a rotating force of a carrier 30 by being engaged with the carrier 30, and a pulley bearing supporting unit 54 which rotatably supports by the pulley bearing 43 at the bottom end. The washing shaft 5 is inserted into the dewatering shaft 6 in the longitudinal direction to rotate thereinside. To this end, the rotation is supported by first and second washing shaft bearings 57 and 58 which are fixed to a hollow unit 64 inside the dewatering shaft 6 at the top and bottom of the washing shaft 5.

The dewatering shaft 6 includes a dewatering shaft main body 61, a tub coupling unit 62 formed at the top end of the dewatering unit 6, to which the tub is coupled, a decelerator coupling unit 63 formed at the bottom end of the dewatering shaft 6 and is spline coupled to the center of a cover 32 of the decelerator 3, allowing the decelerator cover 32 and dewatering shaft 6 to rotate together, and a hollow unit 64 formed inside the dewatering shaft 6, into which the washing shaft 5 is inserted to rotate. The rotation of the dewatering shaft 6 is supported by the first and second dewatering shaft bearings 15 and 16 coupled to the clutch main body 1 (see FIG. 8).

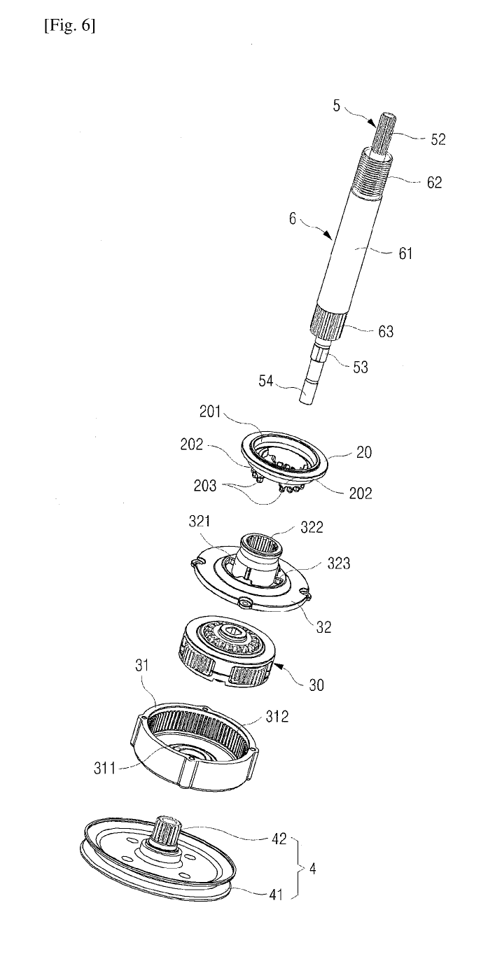

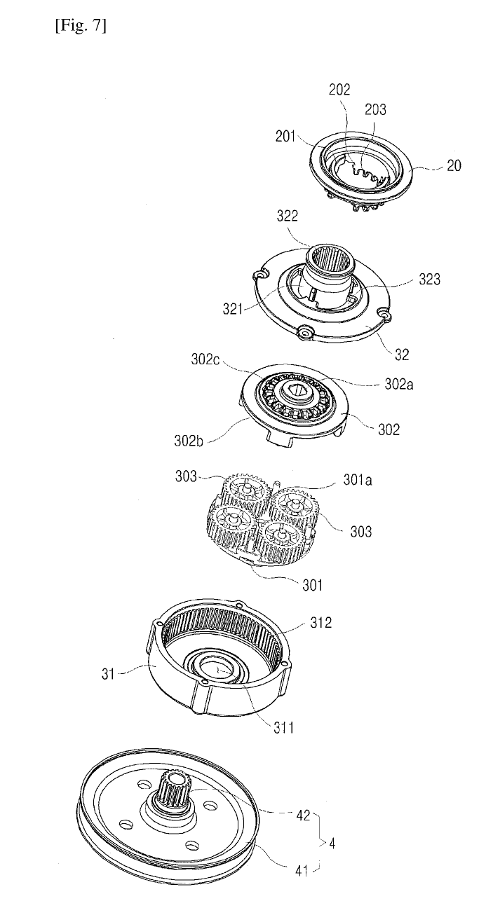

FIG. 6 is an exploded perspective view illustrating the decelerator 3, rotating driving means 4, washing shaft 5 and dewatering shaft 6 of the driving apparatus for a washing machine according to the present invention, and FIG. 7 is an exploded perspective view illustrating the decelerator 3 and rotating driving means 4 of the driving apparatus for a washing machine according to the present invention.

Referring to FIG. 6 and FIG. 7 together, the decelerator 3 of the present invention includes the carrier 30, decelerator main body 31 and decelerator cover 32.

The decelerator main body 31 has a cup shape, and a pulley gear penetrating unit 311 into which a pulley gear 42 penetrates is formed in the center of the bottom thereof. A ring gear 312 is formed inside of a side portion of the decelerator main body 31. The ring gear 312 is engaged with a planetary gear 303. In the washing mode, the carrier 30 rotates inside the ring gear 312 at a decelerated speed. In the dewatering mode, the carrier 30 rotates together with the ring gear 312 at the same rotation speed.

As illustrated in FIG. 7, the carrier 30 includes a carrier bottom main body 301, a carrier top main body 302, and a plurality of planetary gears 303. A pulley gear introduction unit 301a is formed at the bottom of the center of the carrier bottom main body 301. The pulley gear 42 passes through the pulley gear introduction unit 301a to drive a plurality of planetary gears 303. The number of planetary gears 303 is illustrated as four for explanation, but the number may be modified to a proper number according to the necessity. The planetary gears 303 rotate by the driving of the pulley gear 42.

A washing shaft coupling unit 302a is formed in the center of the carrier top main body 302. A rectangular groove is exemplified as the shape of the washing shaft coupling unit 302, but the shape thereof may be modified in a various way such as polygon as long as the rotating force of the carrier 30 can be delivered to the rotation of the washing shaft 5. The shape of the washing shaft coupling unit 302a corresponds to that of the carrier coupling unit 53 of the washing shaft 5. A part of the planetary gear 303 is exposed in a planetary gear exposing unit 302b formed at the side of the carrier top main body 302. The portion exposed is engaged with the ring gear 312 inside the carrier bottom main body 301. A plurality of hole-shaped teeth insertion units 302c are formed around the washing shaft coupling unit 302a at the top of the carrier top body 302. The teeth 203 of the clutch coupler 20 operate as being inserted into or separated from the teeth insertion unit 302c.

The decelerator cover 32 is coupled to the top of the decelerator main body 31, and a center protrusion unit 321 protruding upwardly is formed in the center thereof. A dewatering shaft coupling unit 322 to be spline coupled to the decelerator coupling unit 63 which is formed at the bottom of the dewatering shaft 6 is formed inside the center protrusion unit 321. A coupler penetrating unit 323, which is a space through which the gum 202 of the clutch coupler 20 passes, is formed around the center protrusion unit 321. The number of coupler penetrating unit 323 corresponds to that of the gum 202.

A groove-shaped spring locating unit 201 in which a spring 7 is located is formed inside the top of the clutch coupler 20. The spring 7 is located between the spring locating unit 201 and a bottom center portion of the bottom housing 11 of the clutch main body 1 to give an elastic force to the bottom of the clutch coupler 20. The gum 202 is formed in the clutch coupler 20, protruding downwardly, and the teeth 203 are formed in the gum 202, protruding downwardly. It is preferable that the number of gum 202 is three as illustrated, but is not necessarily limited thereto. Various numbers of gums may be formed symmetrical to each other with respect to the center of circle. The number of teeth 203 may be four as illustrated, but other number than four may be used.

FIG. 8 is a cross section illustrating a state when the driving apparatus of the washing machine according to the present invention is in a washing mode. Referring to FIG. 8 together with FIG. 3, FIG. 6 and FIG. 7, the operation in the washing mode will be explained.

The operation of the brake lever 21 causes the operation of the brake band 14 and brake drum 13 such that the brake drum 13 presses the dewatering shaft 6 not to rotate. The movement of the brake lever 21 operates the clutch lever 22 together. The clutch lever 22 rotates with respect to the hinge unit 223 coupled to the lever holder 23. The clutch lever 22 rotates counterclockwise such that the top lever 221 moves to the bottom and the bottom lever 222 moves to the top. The clutch coupler 20 located in the coupler supporting unit 222a of the bottom lever 222 moves to the top in the washing mode.

Thus, the teeth 203 leaves from the teeth insertion unit 302c of the carrier top main body 302 to the top. In the washing mode, the brake drum 13 presses the dewatering shaft 6 not to rotate. When the pulley 41 rotates by receiving rotation power, the pulley gear 42 rotates together to rotate the planetary gear 303. Since the dewatering shaft 6 coupled to the dewatering shaft coupling unit 322 of the decelerator cover 32 does not rotate, the decelerator cover 32 and decelerator main body 31 do not rotate. Accordingly, since the planetary gear 303 of the carrier 30 rotates along the ring gear 312 inside the decelerator main body 31, the rotation speed of the carrier 30 is slower than that of the pulley 41. Since the dewatering shaft coupling unit 322 of the decelerator cover 32 is fixedly coupled to the decelerator coupling unit 63 of the dewatering shaft 6, the carrier 30 rotates within the fixed decelerator main body 1. The rotation becomes the rotation of the watering shaft 5. Consequently, since the speed of the washing shaft 5 is decelerated to rotate, the pulsator at the end of the washing shaft 5 forms the water current within the washing tub to perform the washing mode.

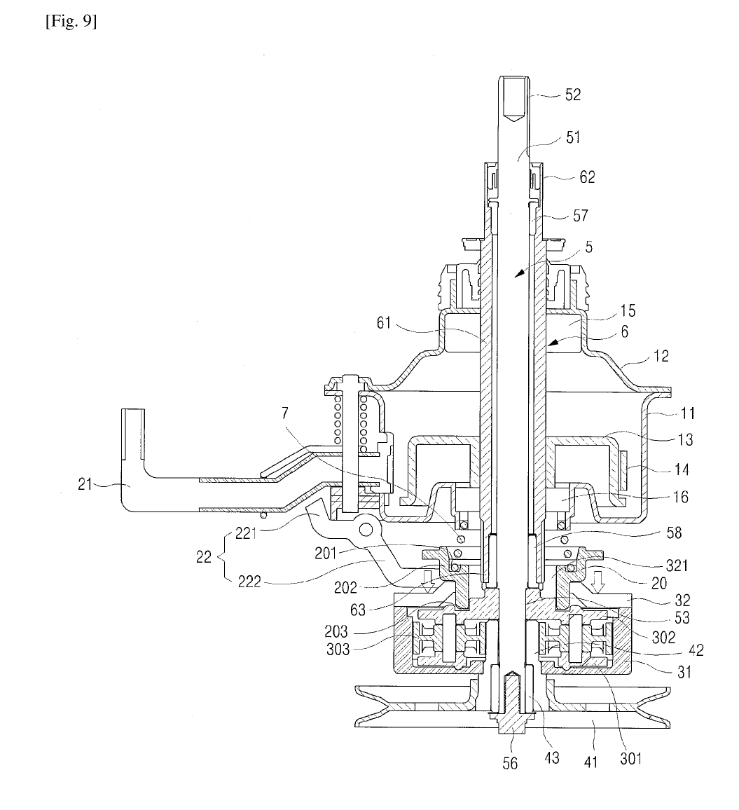

FIG. 9 is a cross section illustrating a state when the driving apparatus of the washing machine according to the present invention is in a dewatering mode. Referring to FIG. 9 together with FIG. 3, FIG. 6 and FIG. 7, the operation in the dewatering mode will be explained.

When the brake lever 21 operates in the direction of A in FIG. 3, the brake band 14 and brake drum 13 are released. The brake drum 13 releases the dewatering shaft 6 so that the dewatering shaft 6 can rotate. The movement of the brake lever 21 operates the clutch lever 22 together. The clutch lever 22 rotates with respect to the hinge unit 223 coupled to the lever holder 23. The clutch lever rotates clockwise such that the top lever 221 moves to the top and the bottom lever 222 moves to the bottom. The clutch coupler 20 located in the coupler supporting unit 222a of the bottom lever 222 moves to the bottom in the dewatering mode.

Accordingly, the teeth 203 are inserted into the teeth insertion unit 302c of the carrier top main body 302. In the dewatering mode, since the brake drum 13 is released, the dewatering shaft 6 can rotate. When the pulley 41 rotates by receiving rotation power, the pulley gear 42 rotates together to rotate the planetary gear 303. Since the dewatering shaft 6 coupled to the dewatering shaft coupling unit 322 of the decelerator cover 32 rotates together, the decelerator 3, carrier 30, washing shaft 5 and dewatering shaft 6 rotate at the same speed. Thus, the planetary gear 303 of the carrier 30 becomes engaged with the ring gear 312 inside the decelerator main body 31, and thereby the carrier 30 and decelerator main body 31 rotate at the same speed. Consequently, the washing shaft 5 and dewatering shaft 6 rotate at the same speed, and the washing tub fixedly coupled to the dewatering shaft 6 rotates. Thus, the dewatering mode is performed such that laundry in the washing tub receives a centrifugal force and moisture contained in the laundry can be discharged to the outside.

The detailed description of the present invention explained as above simply explains one or more examples for understanding the present invention, but does not intend to limit the scope of the present invention. The scope of the present invention is determined by the accompanying claims. Additionally, it should be construed that a simple modification or change falls under the protection scope of the present invention.

1. A driving apparatus for a washing machine, comprising:
a clutch main body 1 in which a brake drum 13 is located inside;
a clutch operation unit 2 installed at one side of the clutch main body 1, the clutch operation unit comprising a brake lever 21 and a clutch lever 22 which rotates together when the brake lever 21 operates;
a clutch coupler 20 located at the bottom of the clutch main body 1, the clutch coupler moving up and down by the clutch lever 22, the clutch coupler being;
a decelerator 3 located at the bottom of the clutch coupler 20;
a rotating driving means 4 located at the bottom of the decelerator;
a washing shaft 5 in which a pulsator is coupled to the top end, the washing shaft being coupled to the rotating driving means 4 and rotating together with the decelerator 3; and
a dewatering shaft 6 in which the washing shaft 5 is rotatably coupled inside and a washing tub is coupled to the top end thereof, the dewatering shaft penetrating a center of the clutch main body 1 and being rotatably coupled thereto.

2. The driving apparatus for a washing machine according to claim 1, wherein the clutch lever 22 comprises a top lever 221 which becomes the top and a bottom lever 222 which becomes the bottom with respect to a hinge unit 223, the hinge unit 223 is coupled to a lever holder 231 fixed at one side of the clutch main body 1, and a top inclination unit 221a with a shape inclined to the side direction is formed in the top lever 221 such that a side inclination unit 211 formed at one side of the brake lever 21 is coupled to move along the top inclination unit 221a.

3. The driving apparatus for a washing machine according to claim 1, wherein the decelerator 3 comprises:
a cup-shaped decelerator main body 31;
a ring gear 312 formed on an inner wall of the decelerator main body 31;
a carrier 30 which comprises a planetary gear 303 engaged to the inside of the ring gear 312; and
a decelerator cover 32 in which a plurality of hole-shaped coupler penetrating units 323 are formed in the center.

4. The driving apparatus for a washing machine according to claim 3, wherein a plurality of gums 202 are formed, protruding downwardly, and a plurality of teeth 203 are formed, protruding downwardly from the gum, in the bottom of the clutch coupler 20.

5. The driving apparatus for a washing machine according to claim 4, wherein a washing shaft coupling unit 302c through which the washing shaft 5 penetrates to be coupled thereto is formed in the center of the carrier, and a plurality of teeth insertion units 302c are formed in the top center of the carrier such that the teeth 203 of the clutch coupler 20 are inserted.

6. The driving apparatus for a washing machine according to claim 1, wherein the rotating driving means comprises:
a pulley 41;
a pulley gear 42 protruding upwardly from the center of the pulley; and
a pulley bearing 43 coupled to the center of the pulley and rotatably supporting the bottom of the washing shaft 5.

7. The driving apparatus for a washing machine according to claim 6, wherein a fastening unit 55 is formed inside the bottom end of the washing shaft 5, and a fastening member 56 is coupled to the fastening unit such that the rotating driving means 4 and washing shaft 5 are coupled to rotate independently.

8. A driving apparatus for a washing machine comprising a clutch main body 1, a dewatering shaft 6 penetrating the center of the clutch main body 1, a washing shaft 5 rotatably coupled inside the dewatering shaft, and a clutch coupler 20 located at the bottom of the clutch main body 1, wherein the clutch main body 1 comprises a brake drum 13 which controls the rotation of the dewatering shaft 6 by the operation of the brake lever 21, the brake lever 21 rotates together with the clutch lever 22 which moves the clutch coupler 20 up and down, the clutch lever 22 comprises a top lever 221 which becomes the top and a bottom lever 222 which becomes the bottom with respect to a hinge unit 223, the hinge unit 223 is coupled to a lever holder 231 fixed at one side of the clutch main body 1, and a top inclination unit 221a with a shape inclined to the side direction is formed in the top lever 221 such that a side inclination unit 211 formed at one side of the brake lever 21 is coupled to move along the top inclination unit 221a.

9. A driving apparatus for a washing machine comprising a clutch main body 1, a dewatering shaft 6 penetrating the center of the clutch main body 1, a washing shaft 5 rotatably coupled inside the dewatering shaft, and a clutch coupler 20 located at the bottom of the clutch main body 1, further comprising:
a rotating driving means causing the rotation of the washing shaft 5, wherein the rotating driving comprises:
a pulley 41;
a pulley gear 42 protruding upwardly from the center of the pulley; and
a pulley bearing 43 coupled to the center of the pulley to rotatably support the bottom of the washing shaft 5.

10. A rotating driving means, comprising:
a pulley 41;
a pulley gear 42 protruding upwardly from the center of the pulley; and
a pulley bearing 43 coupled to the center of the pulley to rotatably support a rotation shaft.
